(19) United States
(12) Patent Application Publication
(10) Pub. No.: US 2008/0148250 A1
(43) Pub. Date: Jun. 19, 2008

(54) Update package generation employing matching technique with controlled number of mismatches

(76) Inventor: Giovanni Motta, Laguna Niguel, CA (US)

Correspondence Address: Kevin Borg;McAndrews, Held & Malloy, Ltd., 500 W. Madison St., Chicago, IL, 60661, US

(21) Appl. No.: 11/590,137

(22) Filed: Oct. 30, 2006

Related U.S. Application Data
(60) Provisional application No. 60/731,348, filed on Oct. 28, 2005.

(51) Int. Cl. G06F 9/44

(52) U.S. Cl. 717/170

(57) ABSTRACT

A generator of update packages with a matching component employs a matching technique that allows matching of programs that have been relocated to (compiled for) different memory segments. In relocated programs, the code remains the same, while the pointers assume different values, and the matching component is able to allow for such changes while still being able to match them. The matching component is able to capture in the flagged mismatches the changed pointers, addresses, etc. and thereby preserving long sections of the code that have not been modified.

### RELATED APPLICATIONS

The present application claims priority to, and is based on, provisional US patent application entitled “GENERATOR OF UPDATE PACKAGES”, filed Oct. 28, 2005, which is hereby incorporated by reference in its entirety.

It is also a continuation of a US Utility patent application titled “TRANSPARENT LINKER PROFILER TOOL WITH PROFILE DATABASE”, and “MOBILE HANDSET NETWORK WITH SUPPORT FOR COMPRESSION AND DECOMPRESSION IN THE MOBILE HANDSET”, both of which are incorporated by reference in their entirety.

The present application is related to PCT Application with publication number WO/02/41147 A1, PCT number PCT/US01/44034, filed 19 Nov. 2001, which in turn is based on a provisional application 60/249,606 filed 17, Nov. 2000, both of which are incorporated by reference in their entirety.

### FEDERALLY SPONSORED RESEARCH OR DEVELOPMENT

Not Applicable

### MICROFICHE/COPYRIGHT REFERENCE

Not Applicable

### BACKGROUND OF THE INVENTION

1. Field of the Invention

The present invention relates generally to the generation of update packages by a generator that can be used to update firmware/software components in mobile handsets.

2. Related Art

Electronic devices, such as mobile phones and personal digital assistants (PDA's), often contain firmware and application software that are either provided by the manufacturers of the electronic devices, by telecommunication carriers, or by third parties. These firmware and application software often contain software bugs. New versions of the firmware and software are periodically released to fix the bugs or to introduce new features, or both.

There is a problem with generating update packages in an efficient mode when at least a portion of the content in a mobile phone image is compressed, or encrypted, or both. There is a problem in minimizing the size of an update package that contains a difference information for a code transition between an old version to a new version.

A common problem in the differential compression of executable files is the pointer mismatch due to code relocation. When a block of code is moved from a memory region to another, all pointers to that region will change accordingly. If in the old version a pointer points to an address A and in the new version of the same code, the same pointer points to B, it is likely that other pointers to A will be changed in the new version into pointers to B. Incorporating such issues into a solution is not easy. In addition, automating the generation of update packages when code changes dramatically between an old version and a newer version is still an art form and prone to errors, and therefore needs tweaking.

The problem of determining a difference between two versions of a code can be addressed in several different ways. One way is to employ a “longest common subsequence” technique, wherein a word w is a longest common subsequence of two string (of bytes for example) x and y if w is a subsequence of x, a subsequence of y and its length is maximal. Dan Gusfield has described an associated technique in “Algorithms on Strings, Trees, and Sequences”, Computer Science and Computational Biology, Cambridge University Press, 1997. However, he has not adequately addressed the challenges when sections of code can move between two versions of the code. However, it does not help to employ the longest common subsequence while comparing two versions of code wherein some blocks code may have been moved, i.e. changed its location. When movement of blocks of code is possible between versions of the code, the longest common subsequence between versions of code is not likely to be useful as the changes in addresses (due to code movement) are likely to make the length of such subsequences small, if not trivial and less useful.

Efficient encoding of references that are relocated by the same offset in the new software version is necessary, but is a complex problem. One related question is when such encoding needs to be conducted. If a block of code contains mismatches, one problem is to decide if mismatches are individually encoded or not. These and other problems are typically encountered during the generation of an update package.

### BRIEF SUMMARY OF THE INVENTION

The present invention is directed to apparatus and methods of generating an update package for mobile devices that are further described in the following Brief Description of the Drawings, the Detailed Description of the Invention, and the Claims. Features and advantages of the present invention will become apparent from the following detailed description of the invention made with reference to the accompanying drawings.

### BRIEF DESCRIPTION OF THE DRAWINGS

FIG. 1 is a perspective diagram of a mobile handset network that employs a generator to generate update packages and an update agent in a mobile device that is capable of updating firmware and software, such as an operating system components or downloadable applications, in the mobile device using the update packages.

### DETAILED DESCRIPTION OF THE INVENTION

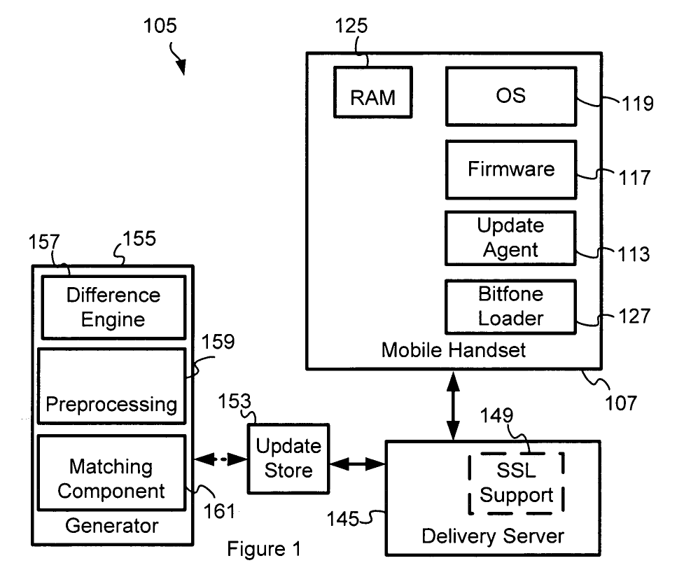

FIG. 1 is a perspective diagram of a mobile handset network 105 that employs a generator 155 to generate update packages and an update agent 113 in a mobile device 107 that is capable of updating firmware 117 and software, such as an operating system components or downloadable applications, 119 in the mobile device 107 using the update packages. The mobile handset network 105 comprises the generator 155 capable of generating update packages that are employed to update firmware 117/software 119 in mobile handsets 107 and an update store 153 that acts as a repository of update packages. It also comprises a delivery server or a management server 145 that dispenses update packages and the mobile device 107 that retrieves update packages from the delivery server or management server 145 to update its firmware 117/software 119.

In general, the update agent 113 is resident in an embedded device, such as a mobile handset 107 (cell phones). The update agent 113 is implemented in hardware in one related embodiment, and in software in another related embodiment, and is employed to use an update package to update firmware 117 and/or software 119 resident in non-volatile memory of the mobile handset 107, such as a NAND based flash memory or a NOR based flash memory. The update process is fault tolerant in the mobile handset 107. Typically, a fault tolerant update agent is employed for such update of firmware or software in the mobile handset 107.

The generator 155 comprises a differencing engine 157 that is used to conducting a differencing algorithm to generate a difference information between one version of a firmware or code and another, a preprocessing module 159 that is used to pre-process code versions, such as an ELF based firmware or code. If necessary, preprocessing component 159 also supports a non-elf preprocessing module that is used to pre-process a non-ELF based firmware or code. That is because the mobile handsets comprise of code, such as firmware and OS, that could be ELF-based or NON-ELF based. For example, the mobile handset 107 may comprise of a firmware that is ELF-based or NON-Elf based.

The generator 155 also comprises a matching component 161 that compares subsections of code between the old and new versions, such as code segments in an older version of firmware and a newer version of firmware. The generator 155 encodes a software package V2 by finding the smallest set of differences from a reference software package V1. Typically, V2 is a more recent software version than V1, so in the following we will refer to these packages also by the names “new” and “old” respectively. The generator encodes differences with a small set of commands that, when executed by the decoder, reconstructs V2 without “loss”. The commands outlined in the generator 155 allow copy of blocks from V1 to V2, insertion of novel data in V2 and small adjustments in a recently copied block (with the use of the commands in the SET_PTR family, for example).

The use of SET_PTR mitigates the well known problem of pointers mismatch due to code relocation. If executable code in V1 appears in V2 in a different memory position, both absolute and relative references may change by making the encoding of a match more expensive.

The matching component 161 is capable of determining the longest common substring between two segments of code, one from the old version and one from the new version. For example, the code can be binary segments of firmware. For matching purposes, the code can be considered to be a sequence of letters (or binary). If w₀,w₁, . . . ,wₘ₋₁ and x₀,x₁, . . . ,xₙ₋₁ are sequences of letters (also words or strings) on the alphabet Σ, then w₀,w₁, . . . ,wₘ₋₁ is a subsequence of x₀,x₁, . . . ,xₙ₋₁ if there exists a strictly increasing sequence of integers k₀,k₁, . . . ,kₘ₋₁ such that for 0≦k≦m−1, wⱼ=xₖⱼ. The letters of w appear in x, scattered but in the same order.

A word w is a longest common subsequence of x and y if w is a subsequence of x, a subsequence of y and its length is maximal. The problem of determining the longest common subsequence among two strings is typically solved by dynamic programming techniques. Let us define w₀,w₁, . . . ,wₘ₋₁ as a substring of x₀,x₁, . . . ,xₙ₋₁ if there exists a 0≦k≦n−m such that for 0≦j≦m−1, wⱼ=xₖ₊ⱼ. Let us also define a word w as a longest common substring of x and y if w is a substring of x, a substring of y and its length is maximal.

For example, given the strings

x=“algorithms on strings” and

y=“natural logarithm found”,

the longest common subsequence between x and y is “algrithm on” since these letters (the space is included) are present in both strings in the same order:

“algorithms on strings”

“natural logarithm found”

Note that there are intervening letters that are not common, such as ‘o’ in ‘algorithms’. On the other hand, if the longest common substring is to be determined it is smaller than the longest common subsequence determined above for the example. The longest common substring is instead “rithm” since this is the longest common sequence of consecutive letters:

“algorithms on strings”

“natural logarithm found”

The matching algorithm used in the matching component 161 of the present invention extends the length of the matches found by the longest common substring technique by allowing a controlled number of mismatches. In the common substrings, the letters have to preserve the respective distances and unlike in the subsequence problem, the matching is “rigid”, with no variable-length insertions allowed.

With reference to the substrings x and y in the previous example, the longest match determined by the matching component 161 between x and y would be “g-rithm-o” where “−”, indicates a mismatch:

“algorithms on strings”

“natural logarithm found”

Since the matching component 161 is targeted, in one embodiment, at the compression of executable code, the matching technique employed allows matching programs that have been relocated to (compiled for) different memory segments. In relocated programs, the code remains the same, while the pointers assume different values. The matching technique employed by the matching component 161 is able to capture in the mismatches the changed pointers and preserve long sections of the code that have not been modified.

The generator 155 of update packages with a matching component 161 employs a matching technique that allows matching of programs that have been relocated to (compiled for) different memory segments. In relocated programs, the code remains the same, while the pointers assume different values, and the matching component 161 is able to allow for such changes while still being able to match them. The matching component 161 is able to capture in the flagged mismatches the changed pointers, addresses, etc. and thereby preserving long sections of the code that have not been modified.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A matching component in a generator of update packages that matches a first version of code to a second version of code, the matching component comprising:
a first string buffer that holds a first string that is derived from the first version of code;
a second string buffer that holds a second string that is derived from the second version of code; and
the matching component extending the length of the matches found by the longest common substring technique by allowing a controlled number of mismatches.

2. The matching component of claim 1 wherein the matching is flexible with variable-length insertions allowed.

3. The matching component of claim 1 wherein the first code version and the second code version are both executable code that can be relocated at least partially and wherein the matching component matches a first segment of first code version with a second segment of the second code version that has been relocated to a different memory segment in the second code version compared to its location in the first code version.

4. A matching component in a generator of update packages that matches a first version of code to a second version of code, the first version of code comprising a first chunk of code, the second version of code comprising a relocated version of the first chunk of code wherein the relocation involves changed memory addresses in the first chunk of code, the matching component comprising:
a first string buffer that holds a first string that is derived from the first version of code and comprises the first chunk of code;
a second string buffer that holds a second string that is derived from the second version of code and comprises the relocated version of the first chunk of code;
the matching component extending the length of the matches found by allowing a controlled number of mismatches; and
the matching component determining a match at least between the first chunk of code and the relocated version of the first chunk of code.

5. The matching component of claim 4 wherein the relocated version of the first chunk of code is a modified version of the first chunk of code wherein the addresses are changed due to relocation in memory.

6. The matching component of claim 4 wherein the relocated version of the first chunk of code is a modified version of the first chunk of code wherein the pointers assume different values.
